(19) United States
(12) Patent Application Publication
(10) Pub. No.: US 2021/0371354 A1
(43) Pub. Date: Dec. 2, 2021

(54) POLYMERISABLE BINDER

(71) Applicant: BAE SYSTEMS plc, London (GB)

(72) Inventors: Amanda Louise Catherall, USK Monmouthshire (GB); Martha Bates, USK Monmouthshire (GB)

(73) Assignee: BAE SYSTEMS plc, London (GB)

(21) Appl. No.: 17/282,038

(22) PCT Filed: Sep. 26, 2019
(86) PCT No.: PCT/GB2019/052708

§ 371 Date: Apr. 1, 2021

(30) Foreign Application Priority Data
Oct. 3, 2018 (GB) 1816112.5

(51) Int. Cl. C06B 45/10; B33Y 70/10; C06B 21/00; B33Y 80/00; C06B 25/28; C06B 25/34

(52) U.S. Cl. CPC C06B 45/10; B33Y 70/10; C06B 25/34; B33Y 80/00; C06B 25/28; C06B 21/0033

(57) ABSTRACT

The invention relates to Polymerisable Binders, and Insensitive Munition (IM) energetic materials particularly to non-phthalate IM propellant compositions which are printed by a UV curing additive layer manufacture process.
invention there is provided an additive layer deposable energetic composition suitable for use as a propellant comprising the following components in the following relative proportions:
component A; from 60% to 95% by weight of a highly energetic filler comprising at least one nitramine compound; and
component B: from 5% to 20% by weight of a binder, wherein the binder contains component D a UV curable binder in the range of from 3% to 12% by total weight of the formulation,
at least one UV photoinitiator,
component C: from 1% to 15% of a plasticiser,
the percentages by weight of components A, B, D and C, together with minor additives, if any, adding to 100%.

The invention relates to Insensitive Munition (IM) energetic materials particularly to non-phthalate IM propellant compositions which are printed by a UV curing additive layer manufacture process.

Low and high energy gun propellants and their energetic compositions, are based on colloidal mixtures of nitroglycerine, nitrocellulose and nitroguanidine (also called picrite) in varying proportions, such as those discussed in GB2371297. The technology used to manufacture these has changed little in 100 years.

Colloidal compositions are, generally, classed as single, double, or, triple base compositions depending on the proportions of the major constituents present (i.e. one, two or three major components, respectively). Other components, e.g. nitramines, have been incorporated to increase the force constant, or, energy level, of these compositions and colloidal compositions comprising three, or, more major components, may be referred to as multibase compositions.

Colloidal propellants, particularly for high energy applications, suffer from the disadvantage that they are highly vulnerable to unwanted ignition when in a hostile environment and subjected to attack by an energetic projectile, e.g. a projectile comprising a shaped warhead charge.

According to a first aspect of the invention there is provided an additive layer deposable energetic composition suitable for use as a propellant comprising the following components in the following relative proportions:

component A; from 60% to 95% by weight of a highly energetic filler comprising at least one nitramine compound; and
component B: from 5% to 20% by weight of a binder, wherein the binder contains component D a UV curable binder in the range of from 3% to 12% by total weight of the formulation,
at least one UV photoinitiator,
component C: from 1% to 15% of a plasticiser,
the percentages by weight of components A, B, D and C, together with minor additives, if any, adding to 100%.

In a preferred arrangement

component A comprises 55% to 75% by weight and
component B comprises 8% to 16% by weight, and
component D comprises 4% to 10% by weight,
component C comprises 5% to 10% by weight
of the said composition, the percentages adding to 100 percent.

The Component D may be a UV curable binder, UV curable binders may also be cured by an electron beam, LED, laser or mercury lamp. The UV curable binder may be selected from any UV curable binder, such as for example epoxide, urethane, vinyl, epoxy, polyether, polyester, acrylate Such as for example BOMAR™, BDT-1015 comprising a multifunctional acrylate, BR-741 aliphatic urethane acrylate, and BRC-843S a hydrophobic urethane acrylate and Jaylink™ JL106-E polymerisable Cellulosic.

The UV curable binder may be capable of being rapidly cured, such as reaching solidification in less than 60 seconds, preferably less than 30 seconds, yet more preferably less than 5 seconds, most preferably a substantially spontaneous cure to form a final cured composition. The rate of curing must be sufficiently quick such that after a first layer of material has been deposed, that the layer is cured such as to allow the next layer to be formed. Alternatively where a flat-bed or Vat photopolymerisation approach is taken, the layer that is selectively hardened in a first pass must be fully cured before the next layer is hardened.

The UV curable binder is selected such that its ability form a cured final product occurs before any significant side-reaction of UV curable groups in the components A, B or C.

The photo initiator may be ionic or free radical, and may be selected to be activated at a desired wavelength, or selected for the specific UV curable binder, component D. The photoinitiaor may be selected from any suitable commercially available photoinitiator, such as for example, 4,4′-bis(diethylamino)benzophenone, 2,4-Diethylthioxanthone, Phenyl bis(2,4,6-trimethylbenzoyl)-phosphine oxide and Ethyl (2,4,6-trimethylbenzoyl) phenyl phosphinate.

The UV cure process may be undertaken by a number of processes such as for example Vat photopolymerisation or direct material/binder jetting, extrusion(FDM). Examples of vat polymerisation may be, such as for example stereolithography, digital light processing, continuous liquid interface production.

The production of explosive formulations may require keeping reagents and explosive contents separate from the final cure of the UV binder stage that is until the last possible moment. Deposition may be preferred to avoid large volumes (vat tank) of explosive formulation to be repeatedly (partially) exposed to UV cure. Deposition may be preferred for large scale manufacture and large volume/mass final shapes.

In compositions according to the present invention, component A provides the high energy capability of the composition. It may be desirable to replace a portion of the highly energetic filler with an IM energetic filler, in the range of from 10-40% wt.

Components B and C provide processability enabling mixtures to be formed together with component A which may be worked into a suitable dough-like material which may be pressed, rolled or extruded to form suitable propellant products. The mutual combination of these components is specially selected in compositions according to the present invention because of the unexpected advantages such a combination provides as follows.

Compositions according to the present invention can be suitably processed to provide propellant materials, e.g. for use as gun or rocket propellants, especially gun propellants, which unexpectedly and beneficially can show an improved, i.e. reduced vulnerability over colloidal propellants, but without a corresponding decrease in energy normally associated with such an improvement.

According to a further aspect of the invention there is provided a method of additive layer manufacturing a binder cured composition as defined herein, comprising the steps of;

a) forming an uncured admixture of components A, B, C, D and photoinitiator,
b) applying, by an energy source in the form of a UV or e-beam source, to a first portion of a surface of the uncured admixture, sufficient to cause the formation of a cured admixture of said first portion;
c) moving the energy source to progressively form a layer of cured admixture;
d) repeating steps a) to c) as required whereby to form the cured admixture in a 3D structure; optionally after step b) causing a second portion of the surface of said uncured admixture to be not subjected to the energy source, such that said second portion contains no cured admixture. The uncured portion may leave an absence of material, to form a cavity or void in the final structure.

According to a yet further aspect of the invention there is provided a method of additive layer manufacturing a binder cured composition as defined herein, comprising the steps of;

a) forming an uncured admixture of components A, B, C, D, and photoinitiator, to be provided at a nozzle,
b) deposing from said nozzle a first aliquot of said uncured admixture,
c) applying, by an energy source in the form of a UV or e-beam source, to said first aliquot of said uncured admixture to form a cured first aliquot
d) moving the nozzle to progressively form a second uncured aliquot, applying, by an energy source in the form of a UV or e-beam source, to said second aliquot of said uncured admixture to form a cured second aliquot,
e) repeating steps a) to d) as required whereby to furnish the cured admixture in a 3D structure; optionally comprising the step after b, of leaving an area with substantially no deposed uncured admixture such that said area contains no cured admixture. The area may leave an absence of material, to form a cavity or void in the final structure.

The component A may be selected from high energy energetic filler, present in the range of 60% to 95% wt. Examples are heteroalicyclic nitramines, such as for example RDX (cyclo-1,3,5-trimethylene, 2,4,6-trinitramine, cyclonite or Hexagen), HMX (cyclo-I,3,5,7-tetramethylene-2,4,6,8-tetranitramine, Octogen) or TATND (tetranitro-tetraminodecalin) and mixtures thereof. Other high energetic fillers may be TAGN, aromatic nitramines such as tetryl, ethylene dinitramine, and nitrate esters such as nitroglycerine (glycerol trinitrate), butane triol trinitrate or pentaerythrital tetranitrate, and inorganic perchlorates and nitrates such as ammonium perchlorate optionally together with metallic fuel such as aluminium particles.

The component A may further comprise an IM energetic filler, said IM filler may be selected from such as, for example, Nitrotriazolone (NTO), Hexanitrostilbene (HNS), Nitroguanidine (Picrite), Triaminotrinitrobenzene (TATB), Guarnylureadinitramide (FOX-12), 1,1-diamino 2,2-dinitro ethylene (FOX-7). The IM energetic filler is one which, without modification, has an FOI greater than 100. Many energetic fillers, including RDX and HMX may be modified, either via stabilisers or coatings such that they have a degree of IM compliance, and an FOI of greater than 100. The component A is selected from a material which is inherently IM, such as will have an FOI>100, without any processing or modification. It has been advantageously found that the inclusion of an IM energetic fill in the amount of from 5% to 25% by weight, provides a final composition which has a high level of IM compliance.

Component B, the binder may be selected from a non-energetic binder and/or an energetic binder, present in the range of from 8% to 16% wt.

Preferably the binder is a mixture of an energetic and non-energetic binder; more preferably the

energetic binder is present in the range of from 5%-10% by weight,

non-energetic binder is present in the range of from 5%-15% by weight, with a total binder % wt in the range of from 8%-16% wt.

Examples of suitable non-energetic binder materials which may be EVA (ethylene-vinyl acetate), cellulosic materials such as esters, ego cellulose acetate, cellulose acetate butyrate, polyurethanes, polyesters, polybutadienes, polyethylenes, polyvinyl acetate and blends and/or copolymers thereof.

Examples of suitable energetic binder materials which may be used alongside a non-energetic binder, are nitrocellulose, polyvinyl nitrate, nitroethylene, nitroallyl acetate, nitroethyl acrylate, nitroethy methacrylate, trinitroethyl acrylate, dinitropropyl acrylate, C-nitropolystyrene and its derivatives, polyurethanes with aliphatic C- and N-nitro groups, polyesters made from dinitrocarboxylic acids and dinitrodiol and homopolymers of 3-nitrato-3 methyl oxetane (PolyNIMMO).

The component B binder may be replaced by only component D the UV curable binder. The composition may only comprise a UV curable binder as the only binder.

The composition comprises component C a plasticiser, wherein the plasticiser comprises a compound formula (A) of from 5% to 10% by weight.

Additional plasticisers which may be selected from a non-energetic plasticiser and/or an energetic plasticiser. Preferably the plasticiser is a mixture of energetic and non-energetic plasticisers; yet more preferably when both are present the;

energetic plasticiser is present in the range of from 0%-8% by weight, and

non-energetic plasticiser, which includes formula (A), is present in the range of from 2%-10% by weight; such that the total plasticiser is preferably 5%-10% wt.

Examples of energetic plasticisers may be Butyl NENA, GAP (glycidyl azide polymer), BDNPA/F (bis-2,2-dinitropropylacetol/formal), dimethylmethylene dinitroamine, bis(2,2,2-trinitropropyl)formal, bis(2,2,2-trinitroethyl)formal, bis (2-fluoro-2,2-dinitroethyl)formal, diethylene gylcol dinitrate, glycerol trinitrate, glycol trinitrate, triethylene glycol dinitrate, tetrethylene glycol dinitrate, trimethylolethane trinitrate, butanetriol trinitrate, or 1,2,4-butanetriol trinitrate.

Examples of Formula (A) may be, Di Octyl adipate(DOA), Di Octyl Sebacate (DOS), dialkyl esters comprising sebacic adipic or maleic homologues, Further non-energetic non-phthalates binders may also be present such as tricresyl phosphate, polyalkylene glycols and their alkyl ether derivatives, eg polyethylene glycol, polypropylene glycol, and diethylene glycol butyl ether.

Preferably, the plasticiser contains only a compound of formula (A), and preferably is present in the range of from 5%-10% wt.

Examples of minor additives may for example comprise one or more stabilisers, e.g. carbamite (N,N1-diphenyl, NN1-diethylurea) or PNMA (para-nitromethylmethoxyaniline); and/or one or more ballistic modifiers, e.g. carbon black or lead salts: and/or one or more flash suppressants, e.g. one or more sodium or potassium salts, e.g. sodium or potassium sulphate or bicarbonate and one or more binder-to-energetic filler coupling agents and one or more antioxidants.

According to a further aspect of the invention there is provided an additive layer deposable energetic composition suitable for use as a propellant comprising the following components, a highly energetic filler, a UV curable binder, a plasticiser, and at least one UV photoinitiator.

The use of additive layer manufacture allows the propellant to be formed into any shape, preferably into a final shape, such that no further process steps are required. The conventional methods produce granules or sticks which are usually formed by cutting to suitable length rods or strands extruded through suitable dies giving a shape. Granules are usually similarly formed by cutting to much shorter lengths rods or sticks obtained by extrusion.

Particularly preferred composition is outlined in Table 1, below.

TABLE 1
IM propellant compositions

| | | Comp |
|---|---|---|
| Component | Ingredient | % wt |
| Component A | RDX | 74.5 |
| Component D | BDT-1015 | 7 |
| Component B | Nitrocellulose | 8.5 |
| Energetic | Butyl Nena | 6 |
| Plasticiser | | |
| Non-energetic | DOS | 3 |
| plasticiser | | |
| stabiliser | Carbamite | 1 |

### EXPERIMENTAL

The formulation from table 1 was prepared, to 100 g of LOVA propellant (RDX, Nitrocellulose, butyl NENA, DOS and carbamate), was added 10 ml of BDT1015 binder and 0.1 ml photoinitiator (2,4-Diethylthioxanthone). A layer of 2 ml was deposed via a syringe to form a deposited line on a substrate. The deposited line was irradiated with a UV lamp (395 nm), the UV binder cured to provide a cured polymerised line.

1. An additive layer deposable energetic composition suitable for use as a propellant and comprising the following components in the following relative proportions:
component A, from 60% to 95% by weight of the composition, wherein component A is an energetic filler comprising at least one nitramine compound;
component B, from 5% to 20% by weight of the composition, wherein component B is a binder;
component C, from 1% to 15% by weight of the composition, wherein component C is a plasticiser; and
component D, from 3% to 12% by weight of the composition, wherein component D includes a UV curable binder and at least one UV photoinitiator;
the percentages by weight of components A, B, C and D, together with minor additives, if any, adding to 100%.

2. The composition according to claim 1, wherein:
component A comprises 60% to 75% by weight of the composition, and
component B comprises 8% to 16% by weight of the composition, and
component C comprises 5% to 10% by weight of the composition, and
component D comprises 4% to 10% by weight of the composition, and
the percentages adding to 100%.

3. The composition according to claim 1, wherein the UV curable binder is a UV curable epoxide, a UV curable urethane, a UV curable vinyl, a UV curable epoxy, a UV curable polyether, a UV curable polyester, or a UV curable acrylate.

4. The composition according to claim 1, wherein the at least one UV photoinitiator is ionic or free radical.

5. The composition according to claim 1, wherein the cure time of the component D is less than 60 seconds.

6. The composition according to claim 5, wherein the cure time is instantaneous.

7. The composition according to claim 1, wherein component A is RDX(cyclo-1,3,5-trimethylene, 2,4,6-trinitramine, cyclonite or Hexagen), HMX (cyclo-1,3,5,7-tetramethylene-2,4,6,8-tetranitramine, Octogen), or TATND (tetranitro-tetraminodecalin), or mixtures thereof.

8. The composition according to claim 1, wherein component A comprises Nitrotriazolone (NTO), Hexanitrostilbene (HNS), Nitroguanidine (Picrite), Triaminotrinitrobenzene (TATB), Guarnylureadinitramide (FOX-12), or 1,1-diamino 2,2-dinitro ethylene (FOX-7).

9. The composition according to claim 1, wherein the plasticiser comprises R₁—OC(O)—R₃—C(O)O—R₂, wherein R₁, R₂, and R₃ are independently selected from C₁ to C₁₀ alkyl, alkenyl.

10. The composition according to claim 1, wherein the plasticiser is selected from di Octyl adipate(DOA), Di Octyl Sebacate (DOS), and dialkyl esters comprising sebacic adipic and maleic homologues.

11. The composition according to claim 1, wherein the component B binder is selected from a non-energetic binder and an energetic binder.

12. A method of additive layer manufacturing a binder cured composition according to claim 1, the method comprising:
a) forming an uncured admixture of components A, B, C, and D;
b) applying, by an energy source in the form of a UV or e-beam source, to a first portion of a surface of the uncured admixture, sufficient to cause the formation of a cured admixture of said first portion;
c) moving the energy source to progressively form a layer of cured admixture; and
d) repeating a) to c) as required whereby to form the cured admixture in a 3D structure.

13. The method of according to claim 12, comprising, after b, causing a second portion of the surface of said uncured admixture to be not subjected to the energy source, such that said second portion contains no cured admixture.

14. A method of additive layer manufacturing a binder cured composition according to claim 1, comprising:
a) forming an uncured admixture of components A, B, C, and D, to be provided at a nozzle;
b) deposing from said nozzle a first aliquot of said uncured admixture;
c) applying, by an energy source in the form of a UV or e-beam source, to said first aliquot of said uncured admixture to form a cured first aliquot;
d) moving the nozzle to progressively form a second uncured aliquot, applying, by an energy source in the form of a UV or e-beam source, to said second aliquot of said uncured admixture to form a cured second aliquot; and
e) repeating a) to d) as required whereby to furnish the cured admixture in a 3D structure.

15. An additive layer deposable energetic composition suitable for use as a propellant, the composition comprising: a highly energetic filler, a UV curable binder, a plasticiser, and at least one UV photoinitiator.

16. The composition according to claim 15, comprising: an insensitive munition (IM) energetic filler.

17. The composition according to claim 15, wherein the at least one photoinitiator is ionic or free radical.

18. The composition according to claim 15, wherein the highly energetic filler comprises RDX(cyclo-1,3,5-trimethylene, 2,4,6-trinitramine, cyclonite or Hexagen), HMX (cyclo-1,3,5,7-tetramethylene-2,4,6,8-tetranitramine, Octogen), or TATND (tetranitro-tetraminodecalin), or mixtures thereof.

19. The composition according to claim 15, wherein the plasticiser comprises di Octyl adipate(DOA), Di Octyl Sebacate (DOS), or a dialkyl ester comprising sebacic adipic and/or maleic homologues.

20. The composition according to claim 1, wherein the energetic filler of component A comprises TAGN, an aromatic nitramine, a nitrate ester, an inorganic perchlorate, a nitrate, or a metallic fuel, or mixtures thereof.
